(19) United States
(12) Patent Application Publication
(10) Pub. No.: US 2020/0316817 A1
(43) Pub. Date: Oct. 8, 2020

(54) METHOD AND APPARATUS FOR RESUMING THE WIRE SAWING PROCESS OF A WORKPIECE AFTER AN UNPLANNED INTERRUPTION

(71) Applicant: SILTRONIC AG, Munich (DE)

(72) Inventors: Alexander RIEGER, Kirchdorf (DE); Walter SPOECKNER, Stubenberg (DE)

(73) Assignee: Silteronic AG, Munich (DE)

(21) Appl. No.: 16/304,847

(22) PCT Filed: Jun. 20, 2017
(86) PCT No.: PCT/EP2017/065082

§ 371 Date: Nov. 27, 2018

(30) Foreign Application Priority Data
Jun. 30, 2016 (DE) 10 2016 211 883.8

(51) Int. Cl. B28D 5/04; B23D 57/00

(52) U.S. Cl. CPC B28D 5/045; B23D 57/0053; B28D 5/0076; B23D 57/0023; B23D 57/0069; B23D 57/0061

(57) ABSTRACT

A substantial reduction in scrap produced by an interrupted process for the sawing of a workpiece into a multiplicity of wafers with a wire saw caused by wire breakage, is made possible by detecting the exact or approximate position of the wire break, repairing or replacing the sawing wire, and rethreading the sawing wire web into the saw kerfs, while excluding the kerf in which breakage occurred.

### CROSS REFERENCE TO RELATED APPLICATIONS

This application is the U.S. National Phase of PCT Appln. No. PCT/EP2017/065082 filed Jun. 20, 2017, which claims priority to German Application No. 10 2016 211 883.8 filed Jun. 30, 2016, the disclosures of which are incorporated in their entirety by reference herein.

### BACKGROUND OF THE INVENTION

### 1. Field of the Invention

The present invention relates to a method for resuming an interrupted process for the sawing of a workpiece into a multiplicity of wafers with a wire saw, which uses a sawing wire covered with abrasive, for example a diamond sawing wire. Furthermore, the present invention also relates to an apparatus for sawing a workpiece into a multiplicity of wafers with a sawing wire, this apparatus making it possible to detect the position of a wire break.

### 2. Description of the Related Art

For electronics, microelectronics and microelectromechanics, semiconductor wafers with extreme requirements for global and local planarity, one-side referenced local planarity (nanotopology), roughness, and cleanness are needed as starting materials (substrates). Semiconductor wafers are wafers of semiconductor materials, in particular compound semiconductors such as gallium arsenide and predominantly, elementary semiconductors such as silicon and sometimes germanium.

According to the prior art, semiconductor wafers are produced in a multiplicity of successive process steps: in a first step, for example, a single crystal (rod) of semiconductor material is pulled by the Czochralski method or a polycrystalline block of semiconductor material is cast, and in a further step the resulting circular-cylindrical or block-shaped workpiece of semiconductor material (ingot) is cut into individual semiconductor wafers by wire sawing.

Wire saws are used in order to cut a multiplicity of wafers from a workpiece made of semiconductor material. DE 195 17 107 C2, DE 10 2011 008 397 A1 and U.S. Pat. No. 5,771,876 describe the functional principle of a wire saw, which is suitable for the production of semiconductor wafers. The essential components of these wire saws include a machine frame, a forward feed device and a sawing tool, which consists of a web (wire web) of parallel wire sections. The spacing of the wires in the wire web depends on the desired target thickness of the wafers to be cut, and for semiconductor material wafers is for example from 100 to 1000 μm. In general, the wire web is formed by a multiplicity of parallel wire sections which are tensioned between at least two wire guide s, the wire guide s being rotatably mounted and at least one of them being a driven wire guide

In contrast to the wire saws described for example in DE 195 17 107 C2 and U.S. Pat. No. 5,771,876, so-called diamond wire saws are also used for sawing a hard workpiece into a multiplicity of wafers. Diamond wire saws differ from wire saws principally in that the sawing wire in a diamond wire saw is covered with abrasive particles of diamonds, so that a higher sawing power is achieved. Diamond wire saws for sawing workpieces of semiconductor material are disclosed, for example, in DE 199 59 414 A1, U.S. Pat. No. 5,878,737 and in EP 2 679 364 A1.

During the cutting process, the workpiece passes through the wire web, in which the sawing wire is arranged in the form of wire sections lying parallel to one another. The passage through the wire web is brought about by means of a forward feed device, which moves the workpiece against the wire web, the wire web against the workpiece or the workpiece and the wire web against one another.

When the wire web penetrates into the workpiece, according to the prior art, for a defined time, a defined length of the sawing wire is fed forward (wire forward) with a particular speed and a further defined length is fed back (wire backward), the backward length WBL generally being shorter than the forward length (WFL). This sawing method is also referred to as a reciprocating movement method and is disclosed, for example, in DE 39 40 691 A1 and in US 2010 1630 10 A2.

EP 1 717 001 B1 teaches that a forward movement and a backward movement are carried out by the sawing wire when sawing a workpiece with a wire saw, the length of the wire during the backward movement (WBL) being shorter than the length of the wire during the forward movement (WFL).

The sawing of a workpiece into many wafers with a wire saw is carried out in the presence of a liquid cutting medium, which inter alia is used to transport the material abraded by the sawing wire out of the sawing gap, and according to the prior art is applied onto the sawing wire. The cutting medium is simultaneously used as a coolant, i.e. to remove from the sawing gap the heat produced during the cutting of the workpiece.

When using wire saws comprising a sawing wire without fixed abrasive, the abrasive is supplied in the form of a suspension (cutting medium suspension, sawing slurry, slurry) during the cutting process. If the sawing wire is covered with a cutting coating, for example diamond, a cutting medium without abrasive is generally used, since.

As mentioned in WO 2013/113859, the liquids used during diamond wire sawing, which contain water for cost reasons and for better heat dissipation, must also contain high proportions of glycols and additives, for example dispersants, silicate inhibitors and wetting agents, since the silicon abrasion reacts with water to form silicates, and is deposited and clumps.

During the cutting of wafers from a workpiece, high mechanical and thermal loading of the sawing wire in the wire web takes place, which may lead to unplanned interruption of the wire sawing process by wire breaking (wire breakage). In particular, diamond sawing wires are very sensitive to wire damage and wire breaks because of their low elasticity, their high brittleness and high mechanical notch effect.

In the event of wire breaks, the sawing process must be interrupted as rapidly as possible, in order to avoid damage to the wire saw and the material being cut.

In order to be able to detect a wire break immediately and to be able to stop the wire sawing process within a very short time, WO 2011/151022 A1 discloses a method for monitoring wire breaks during the cutting of a workpiece by means of a wire web, in which a direct current is passed through the wire web and generates a voltage across the wire field, which is monitored by a sensor. In the event of a voltage change caused by a wire break, the cutting process is automatically interrupted.

DE 10 2011 008 397 A1 teaches the use of a deflection pulley with torque detection for rapid detection of a wire break. As soon as an abnormal value of the turning resistance of the deflection pulley is measured, the wire sawing process is immediately interrupted. However, the monitoring apparatuses according to the prior art only allow the detection of a wire break, but cannot determine the position of the wire break along the longitudinal axis of the wire guide or of the workpiece.

After a wire break and turning off of the wire saw, the workpiece and the wire web are separated from one another. To this end, for example, the workpiece may be removed upward from the web. After repair of the wire web, the workpiece is reintroduced into the wire web, optionally with slight movement of the sawing wire in the presence of the cutting medium.

The methods known for resuming the wire sawing process after unplanned interruption, for example DE 11 2009 001 747 T5 and DE 10 2012 221 904 A1, are primarily used to avoid degradation of the nanotopography of the wafer surfaces upon resumption of the sawing process.

When resuming the wire sawing process with a sawing wire which is covered with abrasive, for example a diamond sawing wire, after an unplanned interruption only a slight degradation—if any—of the nanotopography of the surfaces of the wafers being sawed occurs.

The Inventor has discovered that, in the sawing gap which has been produced by a sawing wire which is covered with fixed abrasive, and in which a wire break has occurred, the sawing wire with fixed abrasive always breaks again, which may lead to complete loss of the workpiece being sawed.

### SUMMARY OF THE INVENTION

The object of the present invention is therefore to provide a method and an apparatus which, in the event of an unplanned process interruption during the wire sawing of a workpiece of semiconductor material when restarting the process, avoids repeated breaking of the wire at the position of the previous wire break, by widening the web in the gap proximate the break, or excluding the gap in which the break occurred.

### BRIEF DESCRIPTION OF THE DRAWINGS

FIG. 1A shows in a very simplified way the structure of a wire saw for sawing a circular-cylindrical workpiece 6 according to the prior art in plan view.

FIG. 1B shows in a very simplified way the structure of a wire saw for sawing a circular-cylindrical workpiece 6 according to the prior art in side view.

FIG. 2 schematically shows a workpiece 6 having a multiplicity of sawing gaps 7 after an interrupted wire sawing process and after the wire web 5 has been removed from the workpiece.

FIG. 3 shows in a very simplified way the structure of a wire saw for sawing a circular-cylindrical workpiece 6 according to the present invention in side view.

FIG. 4A shows a second embodiment of the wire web 5 for resuming the wire sawing process after its unplanned interruption by a wire break.

FIG. 4B shows a second embodiment of the wire web 5 for resuming the wire sawing process after its unplanned interruption by a wire break.

### DETAILED DESCRIPTION OF THE PREFERRED EMBODIMENT

The invention is thus directed to a method for resuming an interrupted process for the sawing of a workpiece 6 into a multiplicity of wafers with a wire saw, comprising detection of the exact or approximate position of the sawing gap 7 in the workpiece 6 in which the wire break has occurred by at least one sensor 8, repairing or replacing the sawing wire 3, forming a new wire web 5 which consists of many wire sections arranged parallel, this wire web 5 being tensioned by at least two wire guides 4 and the wire sections, which are wetted by a fluid, being introduced into a multiplicity of the sawing gaps 7 already present in the workpiece 6, wherein the wire web 5 is widened in the region of the sawing gap 7 in which the wire break took place, in such a way that either a defined region on the left and right of the sawing gap 7 affected by the wire break or only the sawing gap 7 actually affected by the wire break is excluded from the rethreading of the new wire sections or of the new wire section.

The invention is also directed to an apparatus for sawing a workpiece 6 into a multiplicity of wafers with a sawing wire 3, which is tensioned by at least two wire guides 4 in a wire web 5 comprising a multiplicity of wire sections arranged parallel, wherein the wire sections are monitored by at least one sensor 8 in such a way that, in the event of a wire break, the exact or approximate position of the wire section which is broken can be determined.

The invention is also directed to an apparatus for sawing a workpiece 6 into a multiplicity of wafers with a sawing wire 3, which is tensioned by at least two wire guides 4 in a wire web 5 comprising a multiplicity of wire sections arranged parallel, wherein the wire web 5 newly formed after a wire break is tensioned either by corresponding winding around the at least two wire guides 4 tensioning the wire web 5 or by at least one deflecting pulley 2b at the position or in the region where the wire break has occurred, in such a way that at least the sawing gap 7 in which the wire break has occurred does not have a wire section applied to it when the wire sections are rethreaded into the sawing gaps 7 of the workpiece 6.

Although the present invention relates primarily to workpieces of semiconductor material, it may however be used for the sawing of a workpiece of any desired material with a wire saw.

Both wire saws in which the sawing wire in the wire web contains fixed abrasive, for example diamond abrasive or silicon carbide, and wire saws in which the sawing wire does not comprise an abrasive covering and the cutting power is ensured by a cutting suspension which contains an abrasive and is applied onto the sawing wire during or before the sawing process, can be used in the inventive method and apparatus. Correspondingly, even though the invention described below with reference to the example of a diamond wire saw, i.e. a wire saw in which a sawing wire covered with diamond abrasive is used, the invention may be applied to all wire sawing methods regardless of the sawing wire used.

A workpiece is a geometrical body having a surface consisting of at least two parallel plane faces (end faces) and a lateral face, which is formed by parallel straight lines. In the case of a circular-cylindrical body, the end faces are round and the lateral face is convex. In the case of a cuboid cylindrical workpiece, the lateral face is planar.

A workpiece of semiconductor material is a single crystal or a crystal of semiconductor material, the semiconductor material usually being silicon.

The semiconductor material wafers sawed from the semiconductor material workpiece have a front side and a rear side, as well as a circumferential edge, and are refined in further processing steps.

The features indicated in relation to the embodiments of the method according to the invention which are described below may correspondingly be applied to the apparatuses according to the invention. Conversely, the features indicated in relation to the embodiments of the apparatuses according to the invention which are described below may correspondingly be applied to the method according to the invention. These and other features of the embodiments according to the invention will be explained in the description of the figures and in the claims. The individual features may be implemented either separately or in combination as embodiments of the invention. Furthermore, they may describe advantageous embodiments which are independently protectable.

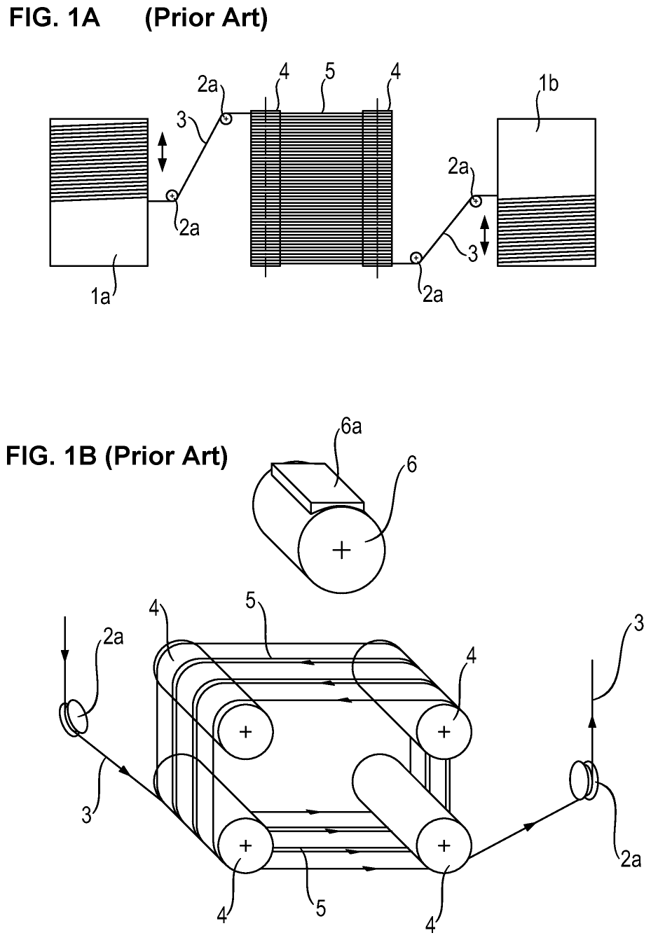

FIG. 1a shows in a very simplified way the structure of a wire saw for sawing a circular-cylindrical workpiece 6 according to the prior art in plan view. The wire saw 3 is guided from a feed spool (1a) via at least one deflection pulley 2a over a wire guide 4 into a wire web 5. The wire web 5 consists of a multiplicity of wire sections arranged parallel and is tensioned by at least two wire guide s 4. The wire sections of the wire web 5 penetrate into the workpiece 6 during the sawing process. The sawing wire 3 fed out of the wire web 5 is wound via at least one further deflection pulley 2a onto a take-up spool (1b).

FIG. 1b shows in a very simplified way the structure of a wire saw for sawing a circular-cylindrical workpiece 6 according to the prior art in side view, the wire web 5 in this representation being tensioned for example by four wire guide rolls 4, and the wire web 5 not being in contact with the workpiece 6, which is fastened in the wire saw by means of a strip 6a. The wire saw 3 is guided from a feed spool (not represented) via at least one deflection pulley 2a over a wire guide 4 into a wire web 5. The wire web 5 consists of a multiplicity of wire sections arranged parallel and is tensioned by four wire guide s 4. The wire sections of the wire web 5 penetrate into the workpiece 6 during the sawing process. The sawing wire 3 fed out of the wire web 5 is wound via at least one further deflection 2a onto a take-up spool (not represented).

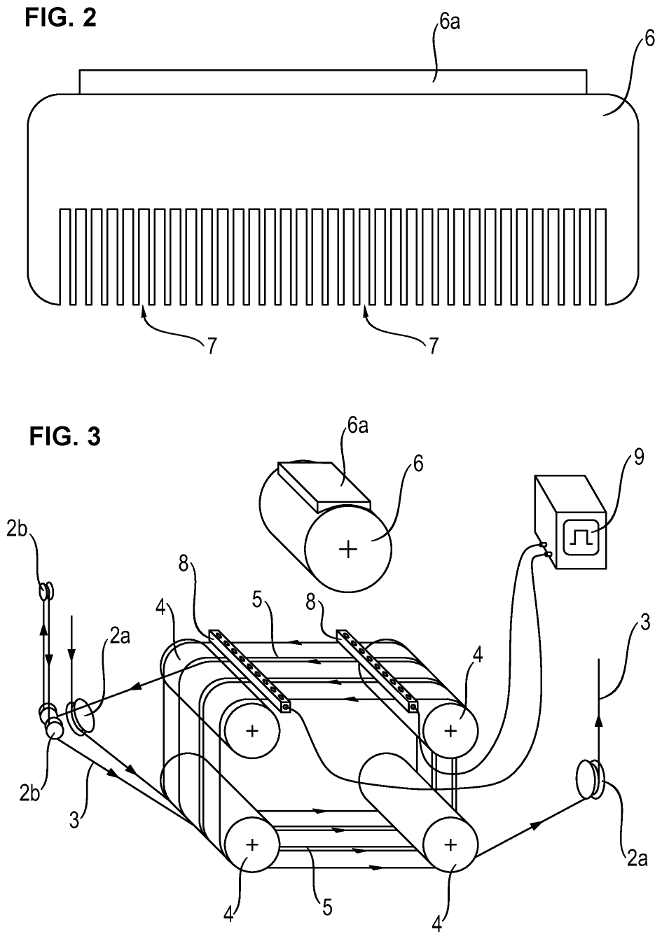

FIG. 2 schematically shows a workpiece 6 having a multiplicity of sawing gaps 7 after an interrupted wire sawing process and after the wire web 5 has been removed from the workpiece.

FIG. 3 shows in a very simplified way the structure of a wire saw for sawing a circular-cylindrical workpiece 6 according to the present invention in side view, the wire web 5 in this representation being tensioned for example by four wire guide rolls 4, and the wire web 5 not being in contact with the workpiece 6, which is fastened in the wire saw by means of a strip 6a. The wire saw 3 is guided from a feed spool (not represented) via at least one deflection pulley 2a over a wire guide 4 into a wire web 5. The wire web 5 consists of a multiplicity of wire sections arranged parallel and is tensioned by four wire guide s 4. The wire sections of the wire web 5 penetrate into the workpiece 6 during the sawing process. The sawing wire 3 fed out of the wire web 5 is wound via at least one further deflection pulley 2a onto a take-up spool (not represented). Below the wire web 5, there are two sensors 8, which are connected to a measuring instrument 9. These sensors 8 are used to monitor the wire web 5, and they detect the position in the wire web 5 where a wire break has occurred. By means of the additional deflection pulleys 2b the wire web 5 is widened in the region in which the wire break has occurred in the workpiece 6, in such a way that this region is bridged, i.e. there are no wire sections.

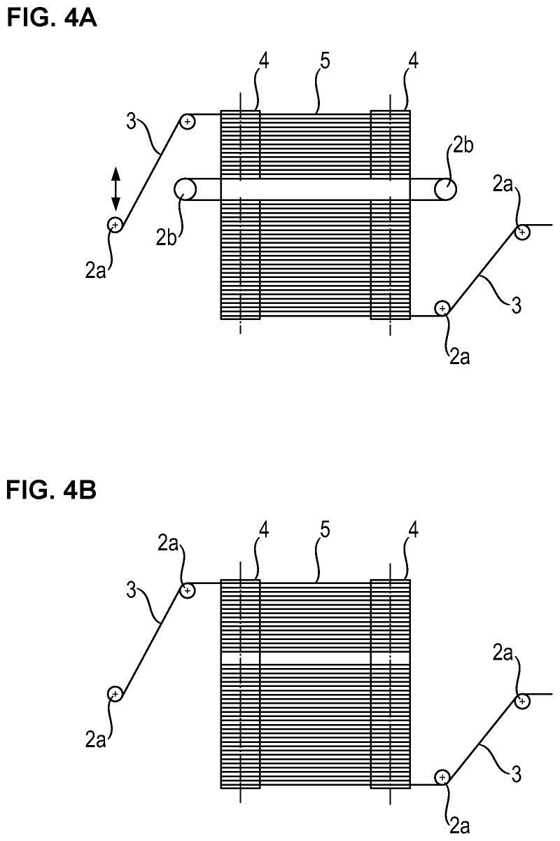

FIG. 4a shows a first embodiment of the wire web 5 for resuming the wire sawing process after its unplanned interruption by a wire break. The repaired wire web 5, which is tensioned by at least two wire guides 4, is tensioned for example respectively by means of an additional deflection pulley 2b in the region in which the wire break has occurred in the workpiece 6 (not represented), in such a way that a region of a plurality of sawing gaps on the left and right of the sawing gaps in the workpiece 6 in which the wire break has occurred, is excluded from the further sawing process, since here the corresponding wire sections are absent in the wire web 5.

FIG. 4b shows a second embodiment of the wire web 5 for resuming the wire sawing process after its unplanned interruption by a wire break. The repaired wire web 5, which is tensioned by at least two wire guide s 4, is tensioned by the wire guide 4 at the position of the wire break in such a way that the sawing gap in the workpiece 6 (not represented) in which the wire break took place is excluded from the further sawing process.

### LIST OF REFERENCES USED

1a feed spool
1b take-up spool
2a deflection pulley for sawing wire 3 between feed roll 1a or take-up roll 1b and wire guide 4
2b deflection pulley for sawing wire 3 from and to the wire guide 4
3 sawing wire
4 wire guide
5 wire web, comprising a multiplicity of wire sections arranged parallel, which is tensioned by at least two wire guide s
6 workpiece
6a strip for fastening the workpiece 6 in the wire saw
7 sawing gap
8 sensor
9 measurement apparatus for recording and evaluating the sensor signal

A diamond wire saw according to the prior art is preferably used in the method according to the invention, since it is possible to saw workpieces 6 into wafers more rapidly with a diamond wire saw than with a wire saw which uses a sawing wire 3 without fixed abrasive. A diamond wire saw for cutting (sawing) workpieces of semiconductor material is disclosed, for example, in U.S. Pat. No. 5,878,737 A. The method according to the invention is, however, also suitable for wire saws which use a sawing wire without fixed abrasive.

The workpiece 6 to be sawed is generally fixed on a sawing strip 6a, which is clamped with a mounting plate in the wire saw. The sawing of the workpiece 6 is carried out with a wire web 5. The wire web 5 is tensioned by at least two wire guide s 4 and comprises a multiplicity of parallel wire sections. The at least two (and optionally three, four or more) wire guides 4 are mounted rotatably and at least one of the wire guides 4 is driven electrically. The wire sections generally belong to a single finite sawing wire 3, which is guided spirally around the wire guide system and is unwound from a feed spool (stock spool) 1a onto a take-up spool (receiver spool) 1b during the sawing process (FIG. 1).

Depending on the wire saw used, sawing wire 3 may be a sawing wire without fixed abrasive or a sawing wire with fixed abrasive.

The diamond sawing wire 3 (diamond wire) is a wire having a core diameter of about 100 μm to 800 μm, which is covered with diamond as abrasive. The diamond particle size generally lies between 15 μm and 150 μm.

The sawing, or penetration, of the wire web 5 into the workpiece 6 is carried out with a forward feed device, which moves the workpiece 6 against the wire web 5, the wire web 5 against the workpiece 6 or the workpiece 6 and the wire web 5 against one another (forward cutting movement). At the same time, the sawing wire 3 is wound from a feed roll 1a via the wire web 5 onto a take-up roll 1b (FIG. 1). As a consequence of this forward feed movement, the wire 3 works by material erosion through the workpiece 6 to form parallel sawing gaps 7, with a comb resulting from the wafers being formed (FIG. 2).

In the case of a sawing wire 3 without fixed abrasive, the wire sections of the wire web 5 preferably have a sawing suspension containing liquid abrasive applied to them through nozzles during the sawing process. The abrasive assists the cutting of the workpiece 6 into a multiplicity of wafers by the wire web 5.

As a cutting medium for a sawing wire 3 without fixed abrasive, all liquid media according to the prior art are suitable. Preferably, for cutting suspensions, glycol, oil or water is used as a carrier material and silicon carbide as an abrasive.

In the case of a diamond sawing wire 3, the wire sections of the wire web 5 preferably have a cooling lubricant applied to them through nozzles during the sawing process. The cooling lubricant is used on the one hand for a better sliding action of the diamond sawing wire 3 in the sawing gap 7, and on the other hand to remove from the sawing gap 7 the heat produced during the cutting of the workpiece.

Water is preferably used as a cooling lubricant, in which case the water may contain additives, for example surfactants. Examples of other cooling lubricants are disclosed, for example, in WO 2013/113859 A1.

The wire sawing of workpieces 6 of semiconductor material is preferably carried out according to the so-called reciprocating movement method (wire oscillation method), that is to say the sawing wire 3 is moved alternately forward and backward in the wire web 5 by a suitable drive, the phase of the forward movement of the sawing wire 3, and therefore the length of wire 3 fed through the sawing gap 7 during the forward movement, being greater than the phase or length of the wire 3 during the backward movement.

The wire sawing of workpieces 6 of semiconductor material may likewise preferably be carried out unidirectionally, that is to say throughout the sawing process the sawing wire 3 in the wire web 5 is moved by a suitable drive in only one direction, i.e. wound from the feed roll 1a to the take-up roll 1b.

If an unplanned interruption of the wire sawing process then occurs by wire breaking, the wire sawing process, consisting of the wire drive and the forward cutting movement, is automatically ended and the wire saw is brought to a stop in a controlled way within a few seconds after the unplanned event.

After an unplanned interruption of the wire sawing process, the workpiece 6 is removed from the wire web 5. If necessary, the torn wire 3 must be removed manually from the workpiece 6.

According to the prior art, the resumption of the wire sawing process with a sawing wire 3 without fixed abrasive takes place after repair or optionally replacement of the sawing wire 3 and formation of the wire web 5 by threading or introduction of the individual wire sections of the wire web 5 into the sawing gaps 7 already present in the workpiece 6.

When using diamond wire 3, full removal of the sawing wire 3, including possible diamond fragments, from the affected sawing gap 7 is clearly not possible, since after repair of the wire web 5 and rethreading of the wire sections into the individual sawing gaps 7, the sawing wire 3 will break again in the same sawing gap directly after restarting. This new breaking of the diamond sawing wire 3 is attributable to residues of the sawing wire 3 and/or broken diamond fragments in the sawing gap 7 affected by the wire break.

Since in general it is not possible to identify externally in which of the many sawing gaps 7 (FIG. 2) the wire break has actually occurred, the workpiece 6 in question is no longer available for a further sawing process and must be disposed of. In order to avoid loss of the workpiece 6 after a wire break, in the method according to the invention on the one hand the wire sections of the wire web 5 are monitored by at least one sensor 8, which is connected to a measurement apparatus 9 for recording and evaluating the sensor signal and which makes it possible at least to narrow down the region in which the wire break has occurred. On the other hand, the region of the sawing gaps 7, or of the sawing gap 7 in which the wire break has occurred, is excluded from the rethreading of the wire sections into the sawing gaps 7 of the workpiece 6.

The method according to the invention therefore comprises, on the one hand, the use of at least one sensor 8 for monitoring the wire web 5 during the wire sawing process. Depending on the sensitivity of the sensor 8 used, it is possible to detect either a region or the approximate position and therefore a limited number of sawing gaps 7 or precisely the sawing gap 7 in which the wire break has occurred. The term “position” relates, in this case, to the site of a torn wire section and therefore of the sawing gap 7 in relation to the rotation axis of the wire guide 4 or the longitudinal axis of the workpiece 6.

On the other hand, after repair of the wire web 5 the wire sections of the latter are rethreaded into the sawing gaps 7 present in the workpiece 6, in such a way that either a defined region on the left and right of the sawing gap 7 affected by the wire break or only the sawing gap 7 actually affected by the wire break is excluded from the rethreading of the new wire sections or of the new wire section. The wire web is widened in the defined region, or on the right and left of the sawing gap 7 affected by the wire break, i.e. the wire web does not contain any wire sections, or a wire section, in this region or at this position.

According to the invention, during resumption of the wire sawing process a new sawing wire 3 is not introduced into the at least one sawing gap 7 in which the wire break occurred, i.e. a small portion of the workpiece 6 is not cut further after resumption of the wire sawing process. The size or length of this portion corresponds at least to the sum of the thickness of the wafers not further cut on the right and left of the sawing gap 7 and the number and width of the corresponding sawing gaps 7. If, for example, wafers with a thickness d=850 μm are being sawed from a workpiece 6 and the width b of the sawing gap is 500 μm, then the length L of the workpiece to be discarded at least is given as L=2200 μm (Lₘᵢₙ=2d+b), since the two wafers on the left and right of the affected sawing gap 7 are not cut further in the method according to the invention.

If the sawing gap 7 in which the wire break has occurred cannot be localized accurately, and a plurality of sawing gaps 7 on the right and left of the sawing gap 7 affected by the wire break are therefore omitted according to the invention in the resumed wire sawing process, the length L of the workpiece 6 to be discarded is increased according to the total number of sawing gaps omitted. If, for example, a total of twenty successive sawing gaps in the workpiece 6 are omitted during the resumption, i.e. no new or repaired sawing wire 3 is fed into these twenty sawing gaps 7, because the sawing gap 7 in which the wire break occurred cannot be determined exactly, the length L of the workpiece 6 to be discarded is increased, with the assumptions made above, to L=2.78 cm (L=21×850 μm+20×500 μm), since twenty sawing gaps 7 affect twenty-one wafers.

Depending on the number of sawing gaps 7 to be omitted during resumption of the interrupted wire sawing process, in the method according to the invention the omission is carried out by two different embodiments, which will be described in detail below.

The basis for the two embodiments is an apparatus for sawing a workpiece 6 into a multiplicity of wafers with a sawing wire 3, which is tensioned by at least two wire guides 4 in a wire web 5 comprising a multiplicity of wire sections arranged parallel, and by at least one sensor 8 makes it possible to monitor the wire sections in such a way that, in the event of a wire break, it is possible to determine the exact or approximate position of the wire section which is torn, or of the sawing gap 7 in which the wire break has occurred in the workpiece 6. Preferably, to this end the at least one sensor is connected to a suitable measurement apparatus 9.

Irrespective of the way in which the wire sawing process is carried out, i.e. as a reciprocating movement method or with a unidirectional wire movement, two sensors 8 are preferably used for monitoring the individual wire sections, so that one sensor 8 respectively lies on each of the two sides of the workpiece 6 which face toward the wire guides 4 tensioning the wire web 5 (FIG. 3).

The at least one sensor 8 for monitoring the wire web 5 may, for example, monitor the individual wire sections electrically, optically, acoustically or in the form of eddy current sensors, and detect the site or position of the wire break relatively accurately by means of the connected measurement apparatus 9, depending on the sensor resolution.

In the preferred embodiment, a sensor 8 which for example operates inductively or is based on the eddy current principle is respectively mounted parallel to the longitudinal axis of the workpiece 6 or to the rotation axis of the wire guide s 4 of the wire web 5 in the wire saw in order to continuously monitor the individual wire sections of the wire web 5 during the wire sawing process (FIG. 3). Depending on the accuracy or resolution of the sensors used, the position of the wire break, and therefore of the affected sawing gap, may be determined exactly or only approximately.

According to the invention, at least one sensor 8 is used for monitoring the wire sections of the wire web 5 during the wire sawing process. The position of the at least one sensor 8 depends on the type of sensor used, so that the positioning of two sensors 8 below the wire web 5, as represented in FIG. 3, does not restrict the invention to this embodiment.

In the embodiment shown in FIG. 3, the length of a sensor 8 preferably corresponds at least to the width of the wire web 5, so that each wire section of the wire web can be monitored by the sensor. If, for example, with a width of 80 cm, a wire web 5 comprises nine hundred individual wire sections, then the sensor in the embodiment shown in FIG. 3 is preferably at least 80 cm wide. However, what is crucial to the invention is that, regardless of its length or design, the sensor 8 can monitor the entire length of the wire web 5, i.e. all wire sections belonging to the wire web 5, during the wire sawing, and can detect the position of a wire section affected by a wire break.

If a wire break occurs during the wire sawing process, i.e. the cutting of a workpiece 6 into a multiplicity of individual wafers, then by the continuous monitoring of the wire web 5 it is possible to determine relatively exactly the precise position of the affected wire section in the wire web 5 and therefore the position of the sawing gap 7 affected by the wire break in the workpiece 6. Besides the resolution and speed of the at least one sensor 8, the accuracy with which the position of the affected wire section can be determined also depends on the situation during the occurrence of the wire break, i.e. for example whether the wire break occurred inside the workpiece 6 or outside the workpiece 6.

If the sawing gap 7 in which the wire break occurred can be determined only approximately, the number of sawing gaps 7 which are excluded according to the invention from the further sawing process depends on the accuracy of the sensor 8 used. The length of the region to be excluded, and therefore the number of sawing gaps 7 to be omitted for the resumption of the wire sawing process, is preferably dimensioned in such a way that the sawing gap 7 affected by the wire break reliably lies in this region, but the region is also not selected to be too large, so that the subsection of the workpiece 6 that can no longer be used is as small as possible.

If, for example, the region in which the sawing gap 7 affected by the wire break lies can be detected only with an accuracy of ten sawing gaps, then, starting from the approximate middle of this region, the region is increased on both sides preferably by at least one half of the measurement accuracy, i.e. in this example respectively five further sawing gaps 7, so that the entire region in which no further cutting is carried out upon resumption of the wire sawing process comprises a total of twenty sawing gaps 7. If there are nine hundred sawing gaps 7 in the workpiece 6 being sawed, for example, then eight hundred and seventy-nine wafers can still be cut from the workpiece 6 after resumption of the sawing process.

In a first embodiment of the method according to the invention, the exclusion of the at least one sawing gap 7 for the resumption of the wire sawing process is carried out by an apparatus for sawing a workpiece 6 into a multiplicity of wafers with a sawing wire 3, which is tensioned by at least two wire guides 4 in a wire web 5 comprising a multiplicity of wire sections arranged parallel, in that the wire web 5 newly formed after a wire break is tensioned by at least one deflecting pulley 2b at the position or in the region where the wire break has occurred, in such a way that at least the sawing gap 7 in which the wire break has occurred does not have a wire section applied to it when the wire sections are rethreaded into the sawing gaps 7 of the workpiece 6.

In the context of this invention, the term “tension” is intended to mean tensioning of the web after omission of one or more wire sections in the wire web.

The first method according to the invention is suitable, in particular, for the resumption of a wire sawing process in which the exact position of the sawing gap 7 affected by the wire break cannot be determined, i.e. a region of a plurality of sawing gaps 7 must be omitted for the resumption of the wire sawing process. The length of this region depends on the accuracy with which it has been possible to determine the sawing gap affected by the wire break.

In principle, the wire break may occur in the edge region of the wire web 5 or in the central region of the wire web. If the wire break has occurred in the edge region of the wire web, then the omission of this region may also be carried out by corresponding positioning of the deflection pulleys 2a, i.e. the wire web 5 is only formed again after a region to be excluded, or the number of sawing gaps 7 to be excluded, relative to the affected edge region.

The following description of the method according to the invention is based on the assumption that the wire break has occurred in a central region of the wire web 5, i.e. there are still a multiplicity of wire sections on the right and left of the region affected by the wire break, the number of these wire sections being greater than the measurement accuracy of the at least one sensor 8.

For the first embodiment of the method according to the invention, in the event of a wire break in the central region of the wire web 5, the wire web 5 must be formed two times. The first part of wire web 5 is formed up to the start of the region which reliably includes the sawing gap 7 affected by the wire break, i.e. the sawing wire 3 is wound as individual wire sections around the at least two wire guides 4. Beyond the start of the region affected by the wire break, the sawing wire 3 is guided outside the first wire guide pulley 4 on one side of the workpiece 6 via at least one, preferably two or three deflection pulleys 2b along the region affected by the wire break, from the start of the latter to its end (FIG. 4a).

The number and/or the size of the deflection pulleys 2b in the apparatus according to the invention for sawing a workpiece 6 into a multiplicity of wafers with a sawing wire 3 are determined by various factors. On the one hand, the length of the region to be bridged on the first wire guide 4 is crucial. This length is given by the number and thickness of the sawing gaps 7 to be omitted. For a longer region, it may be necessary to use larger and/or several deflection pulleys 2b in order to bridge this region. On the other hand, the number and size of the deflection pulleys 2b are determined both by the number of wire guides 4 in the wire saw and by the manner in which the wire 3 is fed back to the wire guide 4 at the end of the region. For example, the wire 3 may return into contact with the respective wire guide 4 above or below the wire guide 4. Furthermore, the position of the at least one deflection pulley 2b with respect to the rotation axis of the wire guide pulley 4 also has an influence on the size and/or number of the deflection pulleys 2b.

The apparatus according to the invention which is required for the method according to the invention comprises at least one deflection pulley 2b, which guides the sawing wire 3 away from a first position on the wire guide 4 and the wire 3 back to a second position on the wire guide, which lies at a certain distance from the first position. The distance between the first and second positions on the wire guide is determined by the number of sawing gaps 7 to be bridged, in which a new wire section for resumption of the interrupted wire sawing process is not placed. The distance is thus also determined by the number of wire sections that are absent in the repaired or newly formed wire web 5. So that the wire sections continue to run parallel in the wire web 5 despite the absent wire sections, the apparatus according to the invention preferably comprises at least one deflection pulley 2b (FIG. 4a) on each of the at least two wire guides 4 tensioning the wire web, positions of which deflection pulleys in relation to the respective rotation axis of the wire guides 4 are oriented in such a way that the wire sections present are still aligned parallel to one another as before.

At the end of the region to be omitted, the sawing wire 3 is fed back to the first wire guide 4, and the second part of the wire web 5 is formed over the at least second wire guide 4. After the formation of the repaired or new wire web 5, the latter comprises a first region with a defined number of wire sections, a second region which contains no wire sections, and a third region which again contains a defined number of wire sections. Depending on the position of the sawing gap 7 affected by the wire break, or the region comprising a particular number of sawing gaps 7 on the left and right of the sawing gap 7 affected by the wire break, the number of wire sections in the first region of the wire web 5 may be equal, similar or entirely different to the number of wire sections in the third region of the wire web 5.

In the method according to the invention, the at least one deflection pulley 2b can preferably be positioned parallel to the longitudinal axis of a wire guide 4. Since a wire 3 covered with fixed abrasive, i.e. for example a diamond wire, has a much greater stiffness than a sawing wire 3 without fixed abrasive, when using a wire 3 covered with fixed abrasive the at least one deflection pulley 2b must have a diameter which reliably does not lead to wire breaking by torsion.

The resumption of an interrupted wire sawing process starts with the introduction of the individual wire sections of the first region of the wire web 5 into the first sawing gap 7 already present in the workpiece 6. The second region of the wire web 5 omits the region comprising a plurality of mutually adjacent sawing gaps 7, in one of which the wire break has occurred, i.e. a new or repaired sawing wire 3 is not introduced into the sawing gap 7 lying in this region. The third region of the wire web 5 is in turn introduced into the remaining sawing gaps 7 of the workpiece 6.

In order to introduce the individual wire sections of the wire web 5 into the sawing gaps 7 already present in the workpiece 6, the sawing wire 3 is preferably wound with a low speed, preferably 0.1-0.5 m/s, in the “wire forward” direction from the stock spool 1a via the wire web 5 and the at least one deflection pulley 2b onto a take-up up spool 1b and the wire web 5 formed by the wire sections arranged parallel is reintroduced into the workpiece 6, in the presence of the cutting medium or cooling lubricant, until the wire sections have again reached the bottom of the sawing gaps 7, i.e. the position in the workpiece at the time of the interruption. When the wire web 5, or the workpiece 6 to be sawed, has again reached the position at the time of the interruption, the wire introduction process is ended and the wire sawing process can be restarted.

According to the first embodiment of the method according to the invention, after the end of the wire introduction process, the wire web 5 is in three parts, both the first part of the wire web 5 and the third part of the wire web 5 each being formed by a defined number of wire sections arranged parallel, which lie in the respective sawing gaps 7 in the workpiece 6 on the right and left of an omitted region along the longitudinal axis of the workpiece 6. The first and third parts of the wire web 5 are separated by the bridging of a region along the longitudinal axis of the at least one wire guide 4 by means of at least one deflection pulley 2b.

Preferably, the individual wire sections of the wire web are also monitored for a wire break by the at least one sensor 8 after the resumption of the interrupted wire sawing process.

After the end of the wire sawing process, it is only necessary to discard a small portion of the workpiece 6, which has been omitted by the second region of the wire web 5.

In a second embodiment of the method according to the invention, the omission of the at least one sawing gap 7, or the widening of the wire web 5, for resumption of the interrupted wire sawing process is carried out by corresponding winding of the sawing wire 3 onto the at least two wire guides 4 tensioning the wire web 5. The second method according to the invention is suitable, in particular, for resumption of a wire sawing process in which the exact position of the sawing gap 7 affected by the wire break can be determined, i.e. only one sawing gap 7 preferably needs to be omitted.

For the second embodiment of the method according to the invention, the wire web 5 needs to be formed only once. At the position of the sawing gap 7 affected by the wire break, or a narrowly limited region of from one to three sawing gaps 7 which lie on the right and left of the sawing gap 7 affected by the wire break, the sawing wire 3 is placed around the at least two wire guides 4 tensioning the wire web 5 in such a way that a new wire section is not introduced into the affected sawing gap 7, and optionally into the neighboring sawing gaps 7. The wire web 5 is widened by means of the respective wire guides 4 in such a way that it does not comprise a wire section, or wire sections, at the position of the affected sawing gap 7, and optionally also the neighboring sawing gaps 7. Starting from the position, in relation to the rotation axis of the wire guide, of the next possible sawing gap 7 which no longer needs to be omitted, the wire web 5 is formed further with the regular spacing of the wire guide sections, so that a wire guide section can again be introduced into the sawing gap 7 following the next possible sawing gap 7.

In the second method according to the invention, the resumption of an interrupted wire sawing process starts with the introduction of the wire web 5 into the sawing gaps 7 already present in the workpiece 6, a new or repaired sawing wire 3 not being introduced into the at least one sawing gap 7 in which the wire break occurred, or in a narrowly limited region of from one to three sawing gaps 7 around this sawing gap 7.

In order to introduce the wire web 5 into the sawing gaps 7 already present in the workpiece 6, the sawing wire 3 is preferably wound with a low speed, preferably 0.1-0.5 m/s, in the “wire forward” direction from the stock spool 1a via the wire web 5 onto a take-up up spool 1b and the wire web 5 formed by the wire sections arranged parallel is introduced further into the sawing gaps 7 present in workpiece 6, in the presence of the cutting medium or cooling lubricant, until the position of the wire web 5 in the workpiece 6 at the time of the interruption is reached.

When the wire web 5, or the workpiece 6 to be sawed, has again reached the position at the time of the interruption, i.e. the wire sections of the wire web 5 have reached the upper end of the respective sawing gaps 7, the wire introduction process is ended and the wire sawing process can be restarted.

Preferably, the individual wire sections of the wire web are also monitored for a wire break by the at least one sensor 8 after the resumption of the interrupted wire sawing process.

After the end of the wire sawing process, it is only necessary to discard a small portion of the workpiece 6, which was affected directly by the wire break.

1.-8. (canceled)

9. A method for resuming an interrupted process for the sawing of a workpiece into a multiplicity of wafers with a wire saw due to a sawing wire break, comprising:
detecting the position of a sawing gap in the workpiece in which the wire break has occurred, or of a number of sawing gaps which lie on the right and left of the sawing gap affected by a wire break, by at least one sensor,
repairing or replacing the sawing wire,
forming a new wire web which consists of many wire sections arranged parallel, this wire web being tensioned by at least two wire guides, and
introducing the wire sections, wetted by a fluid, into a multiplicity of sawing gaps already present in the workpiece, wherein the wire web is widened, in the region of the sawing gap in which the wire break took place, in such a way that either a defined region on the left and right of the sawing gap affected by the wire break or only the sawing gap actually affected by the wire break is excluded from the introducing of the new wire sections or of the new wire section into sawing gaps of the workpiece.

10. The method of claim 9, wherein the widening of the wire web is performed by employing at least one deflecting pulley.

11. The method of claim 9, wherein the widening of the wire web is performed by corresponding winding of the sawing wire onto the at least two wire guides tensioning the wire web.

12. The method of claim 9, wherein the sawing wire is a sawing wire which is covered with fixed abrasive.

13. The method of claim 12, wherein the sawing wire is a diamond covered sawing wire.

14. The method of claim 12, wherein the sawing wire is wetted with water.

15. An apparatus for sawing a workpiece into a multiplicity of wafers with a sawing wire, which is tensioned by at least two wire guides in a wire web comprising a multiplicity of wire sections arranged parallel, wherein the integrity of the wire sections is monitored by at least one sensor in such a way that, in the event of a wire break, the exact or approximate position of the wire section which is broken can be determined.

16. An apparatus for sawing a workpiece into a multiplicity of wafers with a sawing wire, which is tensioned by at least two wire guides in a wire web comprising a multiplicity of wire sections arranged parallel, wherein the wire web newly formed after a wire break is tensioned either by corresponding winding around the at least two wire guides tensioning the wire web or by at least one deflecting pulley at the position or in the region where the wire break has occurred, in such a way that at least the sawing gap in which the wire break has occurred does not have a wire section applied to it when the wire sections are rethreaded into sawing gaps of the workpiece.
